(19) United States
(12) Patent Application Publication
(10) Pub. No.: US 2024/0222644 A1
(43) Pub. Date: Jul. 4, 2024

(54) BATTERY ELECTRODE FOR AN ELECTROCHEMICAL BATTERY CELL

(71) Applicant: Volkswagen Aktiengesellschaft, Wolfsburg (DE)

(72) Inventors: Zhihang Yu, Lengende (DE); Jessica Maria Hüsker, Braunschweig (DE)

(21) Appl. No.: 18/402,548

(22) Filed: Jan. 2, 2024

(30) Foreign Application Priority Data
Jan. 3, 2023 (DE) 102023200012.1

(51) Int. Cl. H01M 4/66; H01M 4/36; H01M 4/38; H01M 4/48; H01M 4/62

(52) U.S. Cl. CPC H01M 4/667; H01M 4/366; H01M 4/386; H01M 4/48; H01M 4/625; H01M 4/661; H01M 2004/021

(57) ABSTRACT

A battery electrode for an electrochemical battery cell, that includes a metallic current collector and a primer interlayer applied thereto, the primer interlayer including a conductive additive and an electrochemically active, silicon-based nano active material.

### RELATED APPLICATIONS

The present application claims priority to German Pat. App. No. DE 102023200012.1, filed Jan. 3, 2023, to Yu Zhihang, the contents of which is incorporated by reference in their entirety herein.

### TECHNICAL FIELD

The present disclosure relates to battery electrodes for an electrochemical battery cell, comprising a metallic current collector and a primer coating applied thereto. The present disclosure furthermore relates to electrochemical battery cells comprising such battery electrodes.

### BACKGROUND

Motor vehicles that are driven or can be driven electrically or by an electric motor, such as electric or hybrid vehicles, in general comprise an electric motor by way of which one or both vehicle axles can be driven. So as to supply electrical energy, the electric motor is usually connected to a vehicle-external (high-voltage) battery, serving as an electrical energy storage system.

As used herein, an “electrochemical battery” should be understood to mean a so-called secondary battery of a motor vehicle. In such a (secondary) vehicle battery, consumed chemical energy can be reversibly converted by means of an electrical (re)charging process. Such vehicle batteries are designed, for example, as electrochemical rechargeable batteries, and in particular as lithium-ion rechargeable batteries.

So as to generate or provide a sufficiently high operating voltage, such vehicle batteries typically comprise at least one battery module (battery cell module), in which several individual battery cells are interconnected in a modular fashion. As an alternative, a so-called Cell2Pack design is possible, in which the battery cells are directly interconnected, and in particular are connected in parallel, to form the vehicle battery and are not combined in modules beforehand.

The battery cells are, for example, designed as electrochemical (thin) film cells. The thin-film cells have a layered composition comprising a cathode layer (cathode) and comprising an anode layer (anode), as well as a separator layer (separator) interposed therebetween. The anodes and the cathodes typically each comprise a film-like, current collector (collector, current collecting member, current collecting component) having an active material (electrode material) applied thereto, into which lithium ion can intercalate (be inserted) and out of which lithium ions can deintercalate (be extracted). These components are penetrated, for example, by a liquid electrolyte, which produces an ion-conducting connection of the components or a charge equalization. Silicon-based (Si-based) active materials are increasingly used for the electrode layers, in particular for the anode, so as to increase the energy density of lithium-ion batteries.

Furthermore, it is desirable for lithium-ion batteries to have the longest service life possible and the highest fast-charging capability possible. To enable or enhance the adhesion of the electrode coating to the current collector, and thereby also improve the fast-charging capability, copper foils are used as current collectors, in particular on the anode, which include so-called primer layers or primer coatings (primer interlayers). The primer layers are usually made of conductive carbon (for example, conductive carbon black) and a binder polymer, which enables the adhesion to the current collector. The primer interlayer usually has increased roughness so as to improve the adhesion of an active material coating applied thereto.

However, it is disadvantageous that such primer interlayers reduce the energy density of the battery cell since these contain inactive materials (such as binders) and do not contain Si-based materials. Primer interlayers are consequently applied as thin as possible, that is, with the lowest possible layer thickness, so that the negative influence on the energy density is reduced.

### SUMMARY

Aspects of the present disclosure are directed to a battery electrode for an electrochemical battery cell, and an associated battery cell.

Some aspects of the battery electrode and/or battery cell are disclosed in the independent claims. Other aspects of the present disclosure are disclosed in the subject matter of the dependent claims. The presented advantages and embodiments with regard to the battery electrode also apply, mutatis mutandis, to the battery cell, and vice versa.

In some examples, a battery electrode is disclosed for an electrochemical battery cell and is suitable and configured therefor. The battery electrode may include a metallic, foil-like, current collector and a primer interlayer applied thereto. The primer interlayer includes a conductive additive and an electrochemically active, silicon-based, nano active material as constituents. In this way, a particularly suitable battery electrode may be implemented.

In some examples, an electrochemical battery cell is disclosed, comprising a battery electrode as described herein. The battery electrode may be accommodated as an anode in a cell stack of the battery cell. This ensures a particularly suitable battery cell having a particularly high energy density.

### DESCRIPTION OF THE DRAWINGS

An exemplary embodiment of the invention will be described in more detail hereafter based on the drawings. The drawings show schematic and simplified illustrations:

FIG. 1 illustrates a battery electrode comprising a primed current collector according to some aspects of the present disclosure; and

FIG. 2 illustrates a battery electrode configured as an anode, according to some aspects of the present disclosure.

### DETAILED DESCRIPTION

In the following description, like parts and variables are denoted by like reference numerals in all the figures.

In some examples, a battery electrode may be configured with Si-based nano active materials introduced into the primer interlayer. These Si-based nano active materials may be configured to be electrochemically active and thus contribute to the capacity of the battery electrode, whereby an energy density of the battery cell is increased. Since the Si-based nano active materials are introduced directly into the primer layer, additionally favorable adhesion of the Si-based active materials over the service life of the battery cell is ensured.

A nano active material should be understood to mean an active material in the form of nanoscale materials or particles. The nano active material is, for example, formed by nanoparticles or nanotubes or nanowires or mixtures thereof.

In some examples, the battery electrode may be configured as an anode, wherein a nano active material accordingly should be understood to mean a nano anode active material. The conductive additives are typical conductive additives that are used in battery anodes or primer interlayers, such as conductive carbon black, carbon black, Ketjen black, nanotubes or the like.

In some examples, the primer interlayer may be uncoated. In other words, the battery electrode can be formed by a primed current collector. Preferably, however, an active material layer, and in particular a silicon-based active material layer, is applied to the primer interlayer. For example, an anode active material is thus applied to the primer interlayer, so that the battery electrode can be used as an anode in a battery cell. The primer interlayer enhances the conductivity and adhesive strength of the paste or of the active material layer to the battery electrode.

Even if nano active material is added, the primer interlayer may still exerts minor influence on the energy density of the battery. So as to further reduce this influence, the primer interlayer, in one advantageous embodiment, only has a layer thickness of between 100 nm (nanometers) and 5 μm (micrometers). In particular, a layer thickness between 500 nm and 1.5 μm is provided.

In some examples, the nano active material, that is, the nanoscale materials or particles, have an average size between 50 nm and 500 nm, and in particular between 50 nm and 250 nm. In other words, the primer interlayer has a layer thickness between a few nano active material layers and a monolayer. This advantageously extends the service life of the battery electrode since, in this way, so-called particle cracking and particle detachment are avoided. Furthermore, a formation of undesirable interphases (SEI) is advantageously avoided.

In some examples, the nano active material may be configured as pure silicon (Si), a silicon oxide (SiOx), or a silicon alloy (Si alloy). For example, the nano active material is formed by Si nanoparticles, Si nanotubes, Si nanowires, or SiOx nano materials doped with lithium (Li) or with magnesium (Mg).

In some examples, the primer interlayer may have a ratio between 99:1 and 1:99 based on the percent by weight (wt %) of conductive additives to nano active materials. The ratio of the conductive additives to the nano active material in percent by weight is preferably designed to range between 75:25 and 50:50.

The primer interlayer can be configured to be binderless, that is, without a binder. Coating methods employed for such a binderless primer interlayer are, for example, chemical vapor deposition (CVD), physical vapor deposition (PVD), sputtering, or atomic layer deposition (ALD).

The primer interlayer, however, can also be designed to additionally include a binder. In such an embodiment, the primer interlayer has a binder content between 2 wt. % and 40 wt. %. Binders used are, for example, typical polymer binders known in battery anodes or primer interlayers (such as CMC, SBR, PAA, PVdF, PTFE and the like). For a primer interlayer containing a binder, the coating method employed can be, for example, slot-die coating, doctor blade coating, or a use of self-assembly of particle structures (superstructures) during the mixing process. The coating process can be carried out in a water-based or solvent-based manner. Alternatively, a dry coating method is also conceivable.

In some examples, the current collector may be configured as a copper foil. The current collector or the copper foil preferably has a layer thickness (film thickness) between 1 μm and 20 μm, and in particular between 4.5 μm and 10 μm, for example 6 μm.

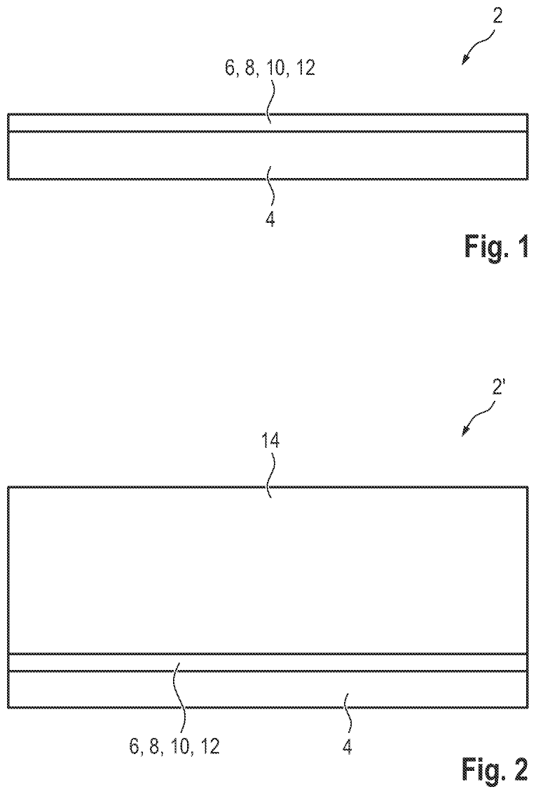

Turning to the example of FIG. 1, the battery electrode 2 is configured for an electrochemical battery cell, which is not shown in greater detail, and is suitable and configured therefor. The battery electrode 2 comprises a metallic, in particular foil-like, current collector 4 and a primer interlayer 6 applied thereto.

The current collector 4 is preferably configured as a copper foil. The current collector 4 has a layer thickness (film thickness) between 1 μm and 20 μm, and in particular between 4.5 μm and 10 μm, for example 6 μm.

The primer layer 6 may be configured with a layer thickness between 100 nm and 5 μm. In particular, the layer thickness is configured to be between 500 nm and 1.5 μm. The primer interlayer 6 includes a conductive additive 8 and an electrochemically active, silicon-based, nano active material 10. The conductive additive 8 is, for example, conductive carbon black, carbon black, Ketjen black, nanotubes, or mixtures thereof. For example, the nano active material 10 is pure silicon (Si), a silicon oxide (SiOx), or a silicon alloy (Si alloy). For example, the nano active material is formed by Si nanoparticles, Si nanotubes, Si nanowires, or SiOx nano materials doped with lithium (Li) or with magnesium (Mg), or mixtures thereof. The nano active material 10 has an average size between 50 nm and 500 nm, and in particular between 50 nm and 250 nm.

The ratio (in percent by weight) of conductive additives 8 to nano active material 10 in the primer interlayer 6 is between 99:1 and 1:99. The ratio of the conductive additives 8 to the nano active material 10 is preferably designed to range between 75:25 and 50:50.

The primer interlayer 6 can be configured to be binderless, that is, without a binder 12. Coating methods employed for such a binderless primer interlayer 6 are, for example, chemical vapor deposition (CVD), physical vapor deposition (PVD), sputtering, or atomic layer deposition (ALD).

The primer interlayer 6, however, can optionally also be configured to include a binder 12. In such an embodiment, the primer interlayer 6 has a binder content between 2 wt. % and 40 wt. %. Binders 12 used are, for example, typical polymer binders known in battery anodes or primer interlayers (such as CMC, SBR, PAA, PVdF, PTFE and the like), or mixtures thereof. For a binder interlayer 6 containing a binder 12, the coating method employed can be, for example, slot-die coating, doctor blade coating, or a use of self-assembly of particle structures (superstructures) during the mixing process. The coating process can be carried out in a water-based or solvent-based manner. Alternatively, a dry coating method is also conceivable.

FIG. 2 shows a battery electrode 2′ designed as an anode, in which the primer interlayer 6 acts as an adhesive layer for a silicon-based active material layer 14. An anode active material, serving as the active material layer 14, is thus applied to the primer interlayer 6, so that the battery electrode 2′ can be used as an anode in a battery cell.

The present disclosure is not limited to the above-described exemplary embodiments. Rather, other variants of the invention may be derived therefrom within the scope of the disclosed claims by those skilled in the art without departing from the subject matter of the claimed invention. In particular, furthermore all individual features described in connection with the various exemplary embodiments can also be combined with one another in a different manner within the scope of the disclosed claims, without departing from the subject matter of the invention.

### LIST OF REFERENCE NUMERALS

2, 2′ battery electrode
4 current collector
6 primer interlayer
8 conductive additive
10 nano active material
12 binder
14 active material layer

1-10. (canceled)

11. A battery electrode for an electrochemical battery cell, comprising:
a metallic current collector; and
a primer interlayer applied to the metallic current collector, the primer interlayer comprising a conductive additive and an electrochemically active, silicon-based nano active material.

12. The battery electrode according to claim 11, wherein a silicon-based active material layer is applied to the primer interlayer.

13. The battery electrode according to claim 11, wherein the primer interlayer comprises a layer thickness (i) between 100 nm and 5 μm, or (ii) between 500 nm and 1.5 μm.

14. The battery electrode according to claim 11, wherein the nano active material comprises an average size (i) between 50 nm and 500 nm, or (ii) between 50 nm and 250 nm.

15. The battery electrode according to claim 11, wherein the nano active material comprises (i) pure silicon, (ii) a silicon oxide, or (iii) a silicon alloy.

16. The battery electrode according to claim 11, wherein the primer interlayer comprises a ratio, in percent by weight, of the conductive additives to nano active material (i) between 99:1 and 1:99, or (ii) between 75:20 and 50:50.

17. The battery electrode according to claim 11, wherein the primer interlayer (6) additionally includes a binder (12) in a content between 2 wt % and 40 wt %.

18. The battery electrode according to claim 11, wherein the current collector is configured as a copper foil.

19. The battery electrode according to claim 11, wherein the current collector comprises a layer thickness (i) between 1 μm and 20 μm, or (ii) between 4.5 μm and 10 μm.

20. An electrochemical battery cell, comprising:
a battery electrode, the battery electrode comprising
a metallic current collector; and
a primer interlayer applied to the metallic current collector, the primer interlayer comprising a conductive additive and an electrochemically active, silicon-based nano active material.

21. The electrochemical battery cell according to claim 20, wherein a silicon-based active material layer is applied to the primer interlayer.

22. The electrochemical battery cell according to claim 20, wherein the primer interlayer comprises a layer thickness (i) between 100 nm and 5 μm, or (ii) between 500 nm and 1.5 μm.

23. The electrochemical battery cell according to claim 20, wherein the nano active material comprises an average size (i) between 50 nm and 500 nm, or (ii) between 50 nm and 250 nm.

24. The electrochemical battery cell according to claim 20, wherein the nano active material comprises (i) pure silicon, (ii) a silicon oxide, or (iii) a silicon alloy.

25. The electrochemical battery cell according to claim 20, wherein the primer interlayer comprises a ratio, in percent by weight, of the conductive additives to nano active material (i) between 99:1 and 1:99, or (ii) between 75:20 and 50:50.

26. The electrochemical battery cell according to claim 20, wherein the primer interlayer (6) additionally includes a binder (12) in a content between 2 wt % and 40 wt %.

27. The electrochemical battery cell according to claim 20, wherein the current collector is configured as a copper foil.

28. The electrochemical battery cell according to claim 20, wherein the current collector comprises a layer thickness (i) between 1 μm and 20 μm, or (ii) between 4.5 μm and 10 μm.

29. A method for forming a battery electrode for an electrochemical battery cell, comprising:
providing a metallic current collector; and
applying a primer interlayer to the metallic current collector, the primer interlayer comprising a conductive additive and an electrochemically active, silicon-based nano active material.

30. The method of claim 29, further comprising applying a silicon-based active material layer to the primer interlayer
